(19) United States
(12) Patent Application Publication
(10) Pub. No.: US 2014/0223346 A1
(43) Pub. Date: Aug. 7, 2014

(54) Method of Controlling Touch panel

(71) Applicant: InfoPower Corporation, Taipei (TW)

(72) Inventors: Jer-Bin Lin, New Taipei City (TW); Che-Yu Lee, New Taipei City (TW); Chun-Lin Chen, Tainan City (TW)

(73) Assignee: InfoPower Corporation, Taipei (TW)

(21) Appl. No.: 14/173,755

(22) Filed: Feb. 5, 2014

Related U.S. Application Data
(60) Provisional application No. 61/762,292, filed on Feb. 7, 2013.
(60) Provisional application No. 61/807,777, filed on Apr. 3, 2013.

(51) Int. Cl. G06F 3/0488; G06F 3/0486

(52) U.S. Cl. CPC G06F 3/0488; G06F 3/0486
USPC 715/769

(57) ABSTRACT

While issuing a drag command on a touch panel for simultaneously moving a plurality of selected contents and while a thumbnail of is dragged to a category, all subcategories of the category are automatically displayed by the touch panel. By using the add category, a new category and a new subcategory may also be manually or automatically created for moving the plurality of selected contents.

### CROSS REFERENCE TO RELATED APPLICATIONS

This non-provisional application claims priority of U.S. provisional application 61/762,292 filed on Feb. 7, 2013 and U.S. provisional application 61/807,777 filed on Apr. 3, 2013.

### BACKGROUND OF THE INVENTION

1. Field of the Invention

The present invention relates to a method of controlling a touch panel, and more particularly, to a method of controlling contents displayed on the touch panel.

2. Description of the Prior Art

For a conventional touch panel, while a conventional object dragging command utilized on the conventional touch panel is configured to move some selected file from a first category to a target subcategory of a second category, the subcategory is required to be opened for being displayed on the touch panel so that the selected files can be directly moved to the target subcategory. The abovementioned operations related to the conventional object dragging command bring some inconvenience to a user of the conventional touch panel since the user needs more manipulations in opening the target subcategory before moving the selected files.

### SUMMARY OF THE INVENTION

The claimed invention discloses a method of controlling a touch panel. The method comprises selecting a plurality of contents of a first category displayed on a touch panel in response to a first touch command received by the touch panel, simultaneously moving the plurality of contents on the touch panel in response to a second touch command received on the touch panel, displaying all subcategories of the second category on the touch panel when a thumbnail of the second touch command is dragged to a second category displayed on the touch panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-3 illustrate how to control a touch panel according to one embodiment of the present invention.

FIG. 4 illustrates a flowchart of the method of controlling a touch panel of the present invention according to the embodiment shown in FIGS. 1-3.

FIG. 5 illustrates the user interface automatically creating a new category and a new subcategory of the new category.

FIG. 6 illustrates the user interface automatically creating a new subcategory on an existing category.

### DETAILED DESCRIPTION

For enhancing convenience for utilizing a touch panel while moving files from a first category to a subcategory of a second category, the present invention discloses a method of controlling the touch panel. Note that the touch panel may be a smart pad or a smart phone in some embodiments of the present invention.

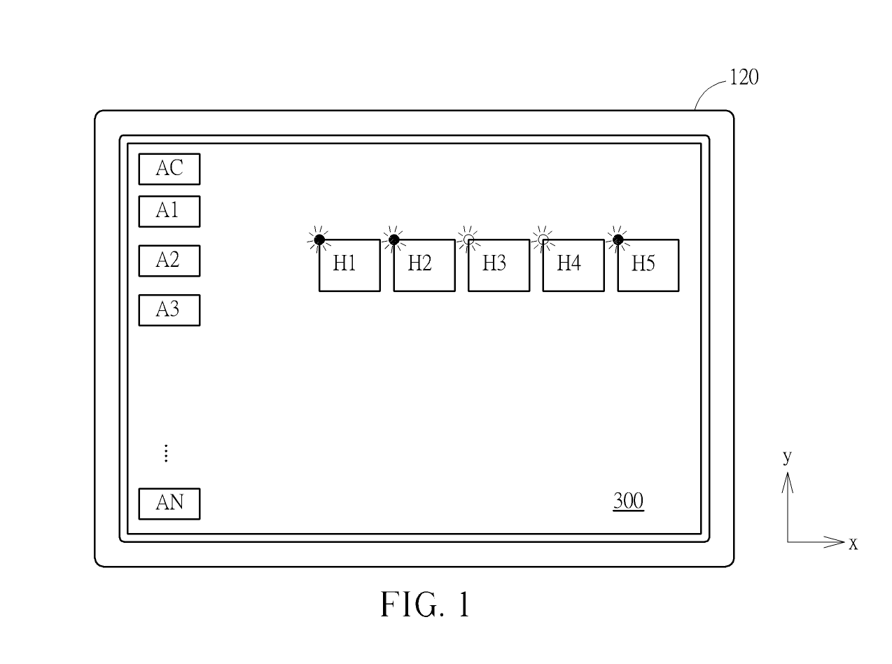

Please refer to FIGS. 1-3, which illustrate how to control a touch panel according to one embodiment of the present invention. As shown in FIG. 1, a user interface 300 is displayed on a touch panel 120. The user interface 300 is configured to present a plurality of categories A1 to AN along the y-axis. As to the user interface 300, each of the contents of the categories A1 to AN may show a symbol in green if the content is selected via a selection touch command received by the touch panel 120 via the user interface 300 and show a symbol in purple is the content is not selected. For example, assume that there are a plurality of contents H1 to H5 in the category A1, and assume that the contents H1, H2, H5 are selected via the selection touch command so that the contents H3 and H4 are not selected, where the contents H1, H2 and H5 have a filled mark indicating their selected statuses, and the contents H3 and H4 have an empty mark indicating their unselected statuses, as shown in FIG. 1.

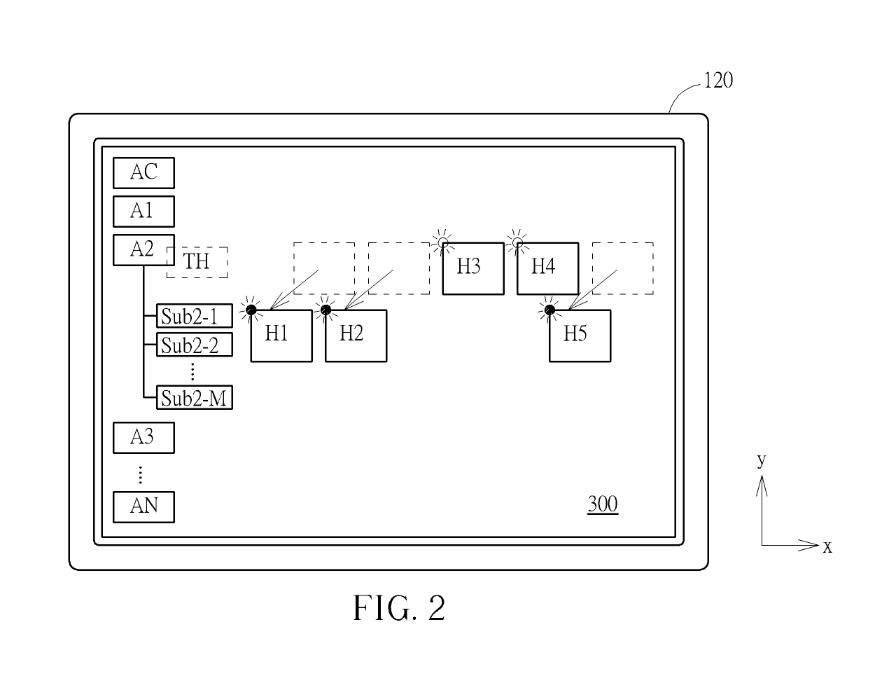

In FIG. 2, assume the user intends to move the selected contents H1, H2 and H5 to a subcategory Sub2-2 of the category A2. Right after the contents H1, H2 and H5 are selected via the selection touch command, the plurality of selected contents H1, H2 and H5 maybe simultaneously moved by the user by dragging and dropping the plurality of selected contents H1, H2 and H5 towards the category A2, i.e., by issuing a drag command for simultaneously moving the plurality of selected contents H1, H2 and H5 on the touch panel 120. Note that in most embodiments of the present invention, the drag command is a single-touch command for simultaneously moving selected contents. A thumbnail TH generated in response to the drag command may be or may not be located on where the finger of the user touches the touch panel 120, and the location of the thumbnail TH is simultaneously moved in parallel with where the finger of the user touches the touch panel 120 under the drag command. At the time when the thumbnail TH is dragged to the category A2, the touch panel 120 automatically displays all subcategories Sub2-1, Sub2-2, . . . , Sub2-N of the category A2 in response, and it saves the user from the burden of additional manual operations for opening the subcategory Sub2-2.

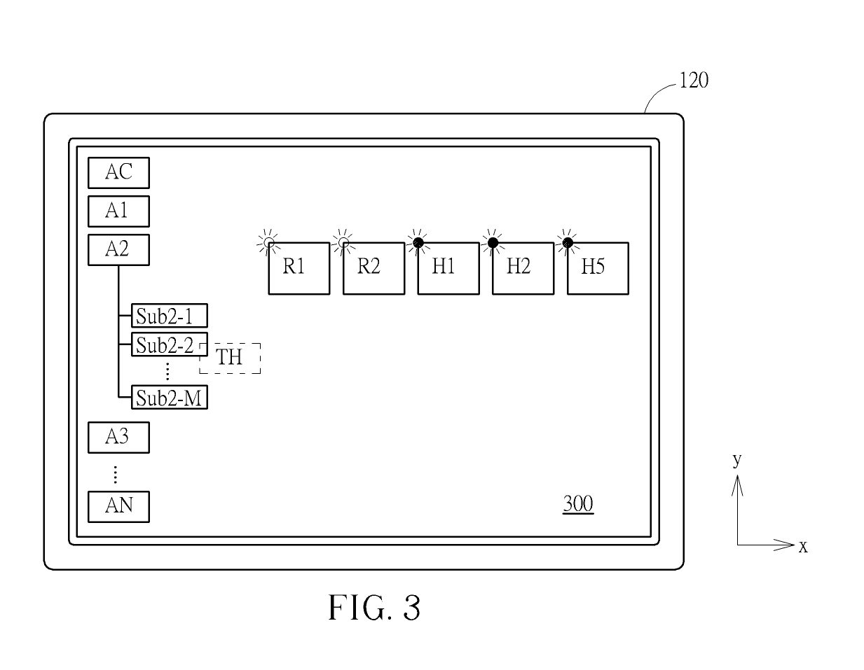

In FIG. 3, after all the subcategories of the category A2 are opened, the user may further drag the thumbnail TH onto and release the thumbnail TH on the subcategory Sub2-2, so that the touch panel 120 is further configured to transfer or copy the selected contents H1, H2 and H5 from the category A1 to the subcategory Sub2-2 of the category A2 in response. Assume that the subcategory Sub2-2 originally has contents R1 and R2, while the selected contents H1, H2 and H5 are copied or transferred to the subcategory Sub2-2, the contents H1, H2 and H5 may be listed right behind the original contents R1 and R2, as shown in FIG. 3.

Note that contents copy or transfer from a subcategory of the category A1 to a subcategory of the category A2 can also be implemented by following the abovementioned steps in some embodiments of the present invention, so the related steps are not repeatedly described.

In some embodiments of the present invention, the contents H1, H2, H3, H4 and H5 may be displayed on a same row by the touch panel 120, as shown in FIG. 1, for convenient browsing of the contents H1, H2, H3, H4 and H5. Similarly, after the selected contents H1, H2 and H5 are copied or transferred to the subcategory Sub2-2, the contents R1, R2, H1, H2 and H5 may also be displayed on a same row of the touch panel 120 for convenient browsing.

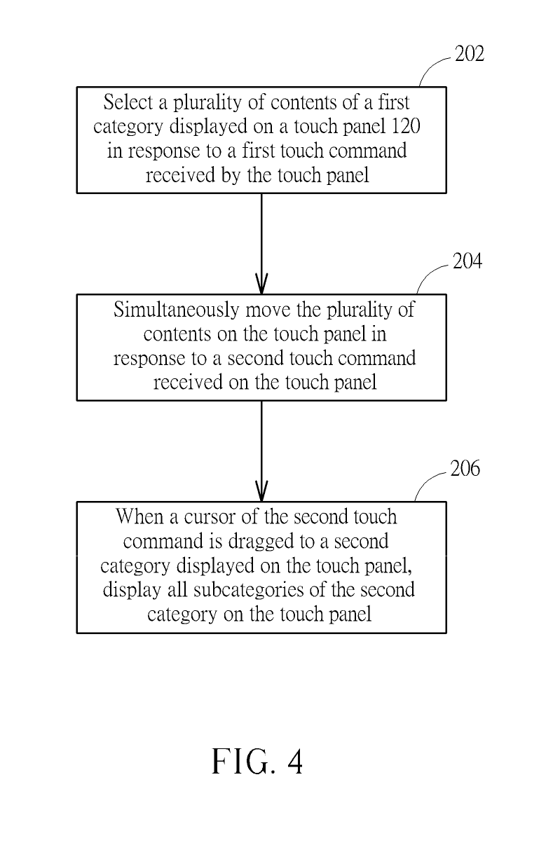

Please refer to FIG. 4, which illustrates a flowchart of the method of controlling a touch panel of the present invention according to the embodiment shown in FIGS. 1-3. As shown in FIG. 4, the method includes the following steps:

Step 202: Select the plurality of contents H1, H2 and H5 of the category A1 displayed on the touch panel 120 in response to a first touch command received by the touch panel 120, i.e., the selection touch command;

Step 204: Simultaneously move the plurality of contents H1, H2 and H5 on the touch panel 120 in response to a second touch command received on the touch panel, i.e., the drag command; and

Step 206: When a thumbnail of the second touch command is dragged to the second category A2 displayed on the touch panel 120, display all subcategories Sub2-1, Sub2-2, . . . , Sub2-N of the second category A2 on the touch panel 120.

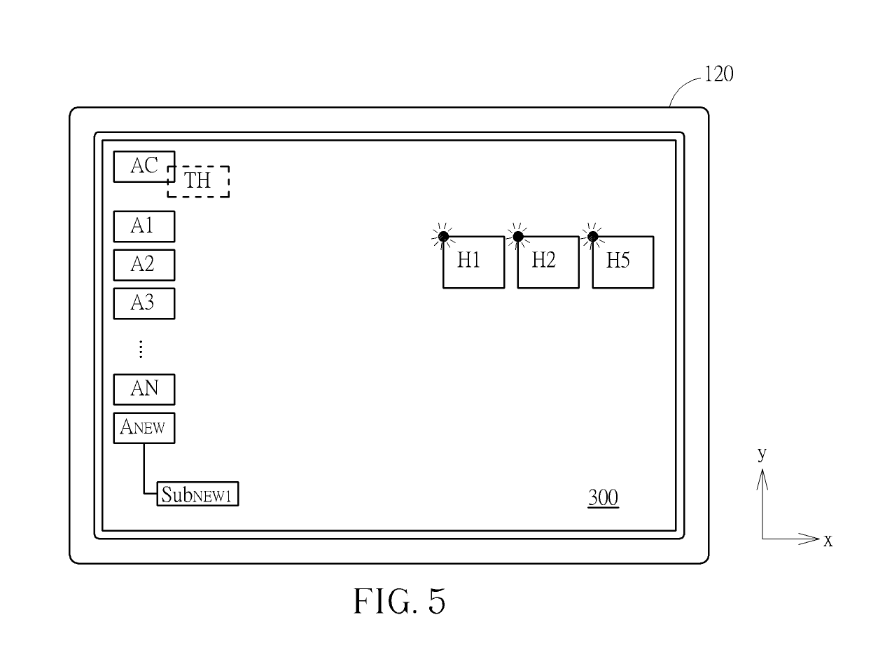

Please refer to FIG. 5. FIG. 5 illustrates the user interface 300 automatically creating a new category A_{NEW} and a new subcategory Sub_{NEW1} of the new category A_{NEW.} The plurality of selected contents H1, H2 and H5 of the category A1 may be selected. The plurality of selected contents H1, H2 and H5 selected may be dragged and dropped on an add category AC and the new category A_{NEW} and the new subcategory Sub_{NEW1} of the new category A_{NEW} are created automatically. And the new subcategory Sub_{NEW1} is disposed under the new category A_{NEW}.

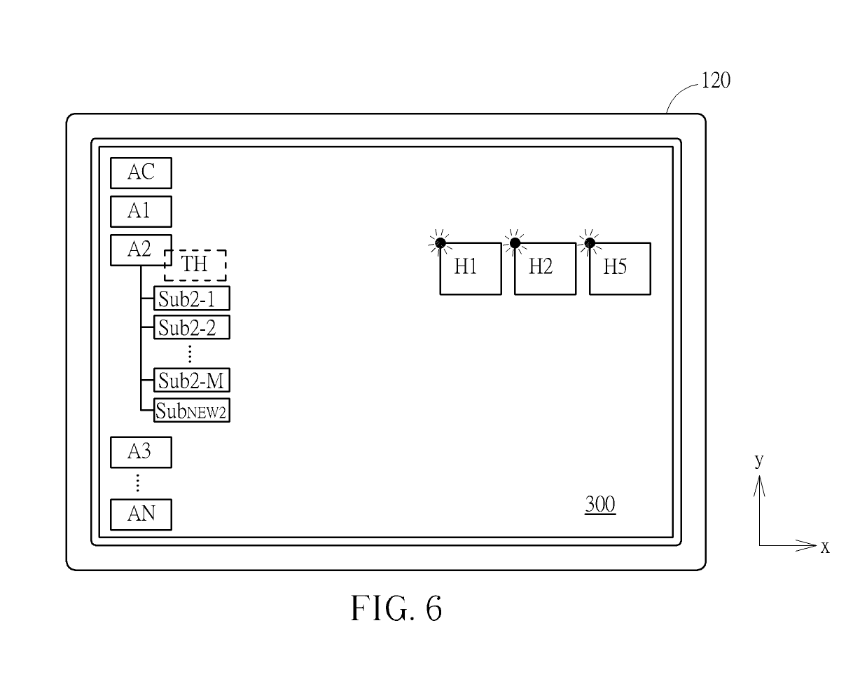

Please refer to FIG. 6. FIG. 6 illustrates the user interface 300 automatically creating a new subcategory Sub_{NEW2} on an existing category. The plurality of selected contents H1, H2 and H5 selected may be dragged and dropped on one of the plurality of categories A1 to AN, i.e. the second category A2 and the new subcategory Sub_{NEW2} under the second category A2 is created. And the new subcategory Sub_{NEW2} is disposed under the second category A2.

Automatic naming of a new category and/or a new subcategory may be based on information that is relevant to the plurality of selected contents H1, H2 and H5, i.e. date created, file type or preprogrammed naming.

By selecting the add category AC, the user may also manually create and name the new category A_{NEW} and the new sub-category Sub_{NEW1} under the new category A_{NEW} manually where the user may choose to place the plurality of selected contents H1, H2 and H5.

Embodiments formed by reasonable combination/permutation of, by adding any abovementioned limitations mentioned in this specification, and/or by changing amounts or objects disclosed in this specification, should also be regarded as embodiments of the present invention.

With the aid of the method of controlling a touch panel disclosed in the present invention, a user of the touch panel can be saved from the burden of using additional operations for opening a target subcategory, so that convenient content browsing/copying/transfer can be fulfilled by following embodiments of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of controlling a touch panel, comprising:
selecting a plurality of contents of a first category displayed on a touch panel in response to a first touch command received by the touch panel;
simultaneously moving the plurality of contents on the touch panel in response to a second touch command received on the touch panel; and
when a thumbnail generated in response to the second touch command is dragged to a second category displayed on the touch panel, displaying all subcategories of the second category on the touch panel.

2. The method of claim 1, further comprising:
when the thumbnail is released on a first subcategory of the second category, copying or transferring the plurality of contents from the first category to the first subcategory.

3. The method of claim 2, further comprising:
displaying all contents of the first subcategory on a same row on the touch panel.

4. The method of claim 1, further comprising:
when the thumbnail is released on an add category, copying or transferring the plurality of contents from the first category to a new subcategory of a new category.

5. The method of claim 1, further comprising:
when the thumbnail is released on the second category, copying or transferring the plurality of contents from the first category to a new subcategory of the second category.

6. The method of claim 1, further comprising:
displaying all contents of the first category on a same row on the touch panel.

7. The method of claim 1, wherein the second touch command is a single-touch command.

8. The method of claim 1, wherein the touch panel is a smart pad or a smart phone.
